(19) United States
(12) Patent Application Publication
(10) Pub. No.: US 2026/0171959 A1
(43) Pub. Date: Jun. 18, 2026

(54) A SUNSHADE SOLAR POWER SYSTEM

(71) Applicants: Adrián RIGAL, Surrey Hills (AU); Jorge MOLL, Surrey Hills (AU)

(72) Inventors: Adrián RIGAL, Surrey Hills (AU); Jorge MOLL, Surrey Hills (AU)

(21) Appl. No.: 19/125,021

(22) PCT Filed: Oct. 27, 2023
(86) PCT No.: PCT/AU2023/051082

§ 371 Date: Apr. 28, 2025

(30) Foreign Application Priority Data
Oct. 31, 2022 (AU) 2022903235

(51) Int. Cl. H02S 30/20; A45B 23/00; A45B 25/24; H02J 7/35; H02J 7/70; H02J 7/80

(52) U.S. Cl. CPC H02S 30/20; A45B 23/00; A45B 25/24; H02J 7/35; H02J 7/751; H02J 7/80; A45B 2023/0006; A45B 2200/1018; A45B 2200/1027

(57) ABSTRACT

The sunshade solar power system enhances traditional sunshades, such as umbrellas and gazebos, by integrating solar panels into their fabric coverings. These panels collect solar energy and store it in a rechargeable battery, allowing users to charge electronic devices through conveniently placed charging ports, such as USB ports. The system may include smart features like charge sensors and controllers to optimise energy usage. It may switch between using solar power and stored battery power, making it highly efficient, particularly when weather conditions affect solar panel output. The flexible solar panels may be designed to fold with the sunshade when it's stowed, ensuring practicality and ease of use. Additionally, a detachable solar panel attachment may be provided to offer flexibility for different sunshade types. Overall, this sunshade solar power system provides an eco-friendly and convenient way to harness solar energy for various outdoor activities.

### FIELD OF THE INVENTION

This invention relates generally to a system for harnessing solar energy using sunshades such as beach umbrellas, gazebos and the like and which comprises solar powering circuitry for recharging an electronic device operably coupled thereto in use.

### BACKGROUND

A sunshade, such as an umbrella, is a portable and collapsible device designed to provide protection from the sun's intense heat and harmful UV rays. It consists of a fabric canopy attached to a collapsible frame with a handle, allowing individuals to shield themselves from direct sunlight. Sunshades are commonly used for personal comfort and to prevent sunburn when outdoors. They come in various sizes and designs, including compact umbrellas for rain and larger ones specifically designed for sun protection.

Portable sunshades come in various forms beyond umbrellas, offering versatile options for sun protection outdoors. One popular choice is a pop-up canopy or gazebo, which is a larger and more spacious sunshade. These structures typically have a metal or plastic frame with a fabric or polyester canopy that provides shade over a larger area. They are ideal for outdoor events, picnics, and gatherings. Beach tents are another type of portable sunshade, designed with lightweight materials and easy setup for beachgoers to relax and seek shelter from the sun on sandy shores. Additionally, there are sunshades specifically crafted for use on outdoor furniture, such as patio umbrellas or awnings, which attach to the exterior of buildings to provide extended shade. These diverse options cater to different outdoor activities and preferences, ensuring comfort and protection from the sun.

These types of portable sunshades, including gazebos, beach tents, and patio umbrellas, typically feature a large fabric covering that is exposed to sunlight during outdoor use.

The present invention provides a practical and convenient way to harness this solar energy. By integrating solar panels or photovoltaic cells into the design of these sunshades, it allows the collection of solar energy directly from the fabric canopy. This harvested energy can then be utilized for various purposes, such as charging electronic devices, powering LED lights for nighttime use, or even providing electricity for small appliances. This innovative approach not only enhances the functionality of sunshades but also promotes sustainable and eco-friendly outdoor living.

### SUMMARY OF THE DISCLOSURE

There is provided herein a sunshade solar power system that can be applied to various sunshade structures, including umbrellas, gazebos, and similar types.

The sunshade features a support frame and a fabric covering with solar panels integrated into its upper surface. These solar panels are used to collect solar energy, which can be stored in a rechargeable battery, preferably a lithium-ion battery.

Electrical wiring connects the solar panels to the battery and, if applicable, a power controller. The power controller regulates the voltage and enables a charging port, such as a USB port, to charge electronic devices.

The charging port may be conveniently located at the lower end of the sunshade shaft. The system may also include features like a charge sensor to monitor the battery status, charge indicators, and a charge controller to optimize battery charging.

In certain conditions, the system can bypass the battery and draw power directly from the solar panels.

The solar panels are preferably flexible and designed to fold with the sunshade when stowed.

In embodiments, the system has a detachable solar panel attachment, which can be used with the sunshade to provide added solar power capabilities.

This innovation enhances the functionality of sunshades by harnessing solar energy in a practical and convenient manner, making them more sustainable and versatile for outdoor use.

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 shows solar powering circuitry in accordance with an embodiment;

FIG. 2 shows a side perspective view of a sunshade solar power system in accordance with an embodiment

FIG. 3 shows a top view of the system in accordance with an embodiment;

FIG. 4 shows a further top view of the system in accordance with an embodiment;

FIGS. 5-7 illustrate how a solar panel of the system is configured to bend or fold up when the structure is collapsed;

FIG. 8 shows an embodiment wherein the system comprises a solar panel attachment;

FIG. 9 illustrates the foldability of the solar panel attachment;

FIG. 10 shows the solar panel attachment attached to an upper surface of an umbrella;

FIG. 11 illustrates folding of the umbrella with the solar panel attachment attached;

FIG. 12 shows a carry case designed to separately carry the umbrella and the solar panel attachment;

FIG. 13 shows an embodiment of an umbrella having a distal end cap having a charging port or intake port installed therein;

FIG. 14 shows an embodiment wherein the solar panel attachment is designed to attach to a rectangular structures such as a gazebo;

FIG. 15 shows the solar panel attachment attached to an upper surface of an umbrella; and

FIG. 16 shows a top plan view of the solar panel attachment when opened.

### DESCRIPTION OF EMBODIMENTS

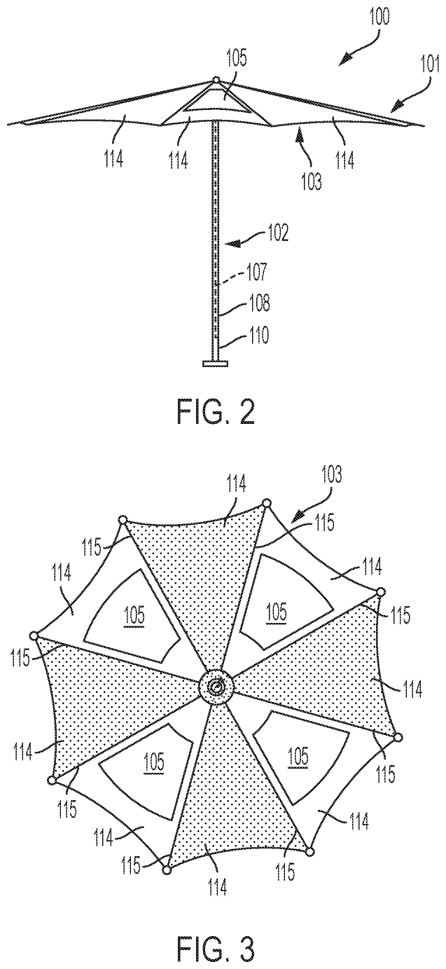

FIG. 2 shows sunshade solar power system 100 comprising a sunshade 101 which takes the form of an umbrella, such as a beach umbrella or the like. However, other types of structures 101 are envisaged including gazebos as indicated in FIG. 14 and the like.

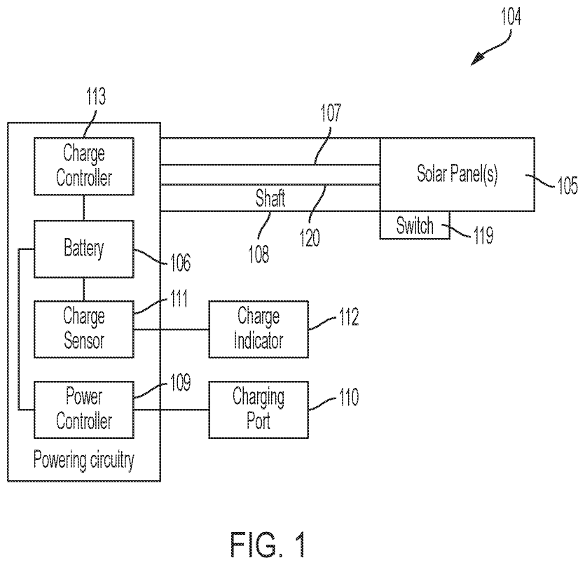

The structure 101 has a support frame 102 and a fabric covering 103. The fabric covering 103 defines an upper surface. The system 100 further comprises circuitry 104 as is shown in FIG. 1.

The circuitry 104 comprises at least one solar panel 105 located across the upper surface of the fabric covering 103. The circuitry 104 may further comprise a rechargeable battery 106. The rechargeable battery 106 may be a lithium-ion battery in embodiments. The battery 106 may be operably coupled to the solar panel 105 to be recharged thereby.

The electrical wiring 107 may interface the solar panel 105 and the battery 106.

As is shown in FIG. 2, the electrical wiring 107 may be installed in a central shaft 108 of the umbrella. According to the embodiment given in FIG. 14, the electrical wiring 107 may be similarly installed through a hollow leg of a gazebo.

The circuitry 104 may further comprise a power controller 109 operably connected between the battery 106 and a charging port 110. The charging port 110 may be a USB type charging port to which an electrical device such as a mobile phone or the like can be charged. The power controller 109 may regulate the voltage from the battery 106 to 5 V. As is shown in FIG. 2, the charging port 110 may be accessible through the shaft 108 so that power can be drawn from the charging port 108 when the umbrella is open. In this regard, preferably the charging port 110 is located at a located at a lower/proximal end of the shaft 108. Preferably, the charging port is located at a proximal end of the shaft 108 so as to be accessible for recharging even when the umbrella is closed. In this regard, the charging port 110 may be installed on a side or end of a handle of the umbrella.

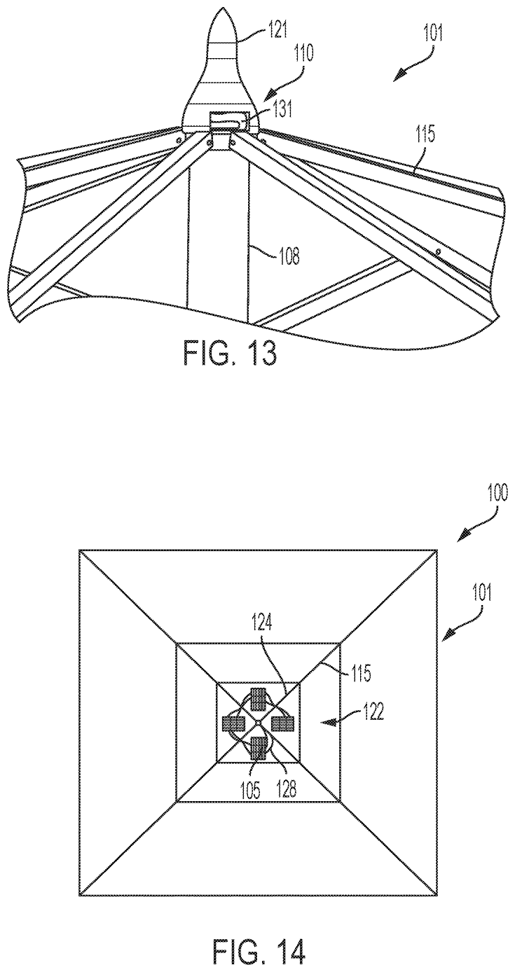

FIG. 13 shows an embodiment wherein the charging port 110 is accessible from a distal end of the umbrella 101. Specifically, in accordance with this embodiment, the umbrella 101 comprises an end cap 121 which protrude beyond the fabric covering 103 irrespective of whether the umbrella 101 is opened or closed. The charging port 110 and may take the form of a USB-C port 131 installed in a side of the end cap 121. As such, a charging cable can be connected to the port 131 irrespective of whether the umbrella 101 is open or closed.

In alternative embodiments, the port 131 is an intake port for the connection of a charging cable of a solar panel attachment 122 as will be described in further detail below.

In embodiments, the circuitry 104 may comprise a charge sensor 111 operably interfacing the battery 106 to measure a charge state thereof. The circuitry 104 may comprise a charge indicator 112 which provides a visible indication of the charge state of the battery 106 as measured by the charge sensor 111.

In embodiments, the charge sensor 111 may interface the power controller 109 to prevent power draw via the charging port 110 when the charge state of the battery 106 is depleted beneath a threshold.

The powering circuitry 104 may further comprise a charge controller 113 interconnected between the electrical wiring 107 and the battery 106. The charge controller 113 may regulate the voltage and/or current of electrical power from the solar panel 105 to appropriately charge the battery 106, including depending on the charge state of the battery 106 as measured by the charge sensor 111.

In embodiments, the circuitry 104 may operate in a battery power bypass mode wherein the power controller 109 provides power to the charging port 110 directly from the solar panel 105.

For example, in direct sunlight, when the solar energy collected by the solar panel 105 exceeds that which is drawn via the charging port 110, the power controller 109 may draw power directly from the solar panel 105 and bypass the battery 106.

However, when passing clouds for example cause the solar energy collected by the solar panel 105 to fall beneath the power drawn via the charging port 110, the power controller 109 may switch across to draw additional power from the battery 106.

The circuitry 104 may comprise current sensors to measure current flowing from the solar panel 105 and current drawn from the charging port 110. Where the current flowing from the solar panel 105 is measured is exceeding the current flowing from the charging port 110, the power controller 109 may bypass the battery 106.

In embodiments, switching may allow the power controller 109 to bypass the battery 106. However, in embodiments, the circuitry 104 comprises a subcircuit allowing the power controller 109 to draw power proportionately from the battery 106 to meet a power shortfall. For example, if 10 W is being drawn from the charging port 110 and the solar panel 105 is only able to supply 6 W, the power controller 109 may draw 4 W from the battery 106.

In embodiments, the sunshade 101 comprises integral lights, such as LEDs. In embodiments where the sunshade 101 takes the form of the umbrella, these lights may be attached under radial arms 115 thereof. These lights may be operably coupled to the battery 106 to provide illumination when dark and which may be operated by a photosensor. Alternatively, the power controller 109 may monitor current or voltage levels provided by the solar panel 105 to detect when darkness falls to automatically illuminate the lights.

The support frame 102 may be collapsible so that the fabric covering 103 is configurable between a deployed configuration as is shown in FIG. 2 wherein the fabric covering 103 is generally flat and a stowed configuration wherein the fabric covering is folded.

The solar panel 105 may be shaped to conform to the geometry of the frame 102.

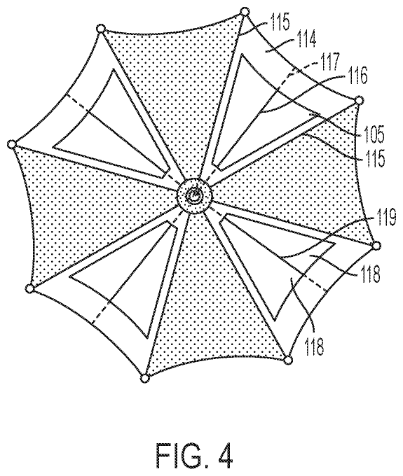

According to the embodiment shown in FIGS. 2-7 wherein the structure 101 is an umbrella 101, the umbrella 101 comprises a plurality of radial arms 115 from an upper end of the shaft 108. When the umbrella 101 is erected, the support arms 115 are splayed apart whereas in the stowed configuration, the support arms 115 lie along the shaft 118.

As is evident from FIG. 3, the solar panels 105 may be generally trapezoidal in shape to maximise the surface area between the radial arms 115.

The solar panels 105 may be permanently attached at sides thereof to the radial arms 115. However, in alternative embodiments as will be described in further detail below, the solar panels 105 may be releasably attached, such as using push buttons, clips or the like.

FIG. 3 shows wherein the fabric covering 103 is defined by a plurality of fabric panels 114 between the support arms 115. FIG. 3 further shows wherein the system 100 may comprise a plurality of solar panels 105 across the upper surface of the fabric covering 103. In the embodiment shown, solar panels 105 are deployed on the panel 114 alternately. However, in embodiments, the solar panel 105 may be provided on each panel 114.

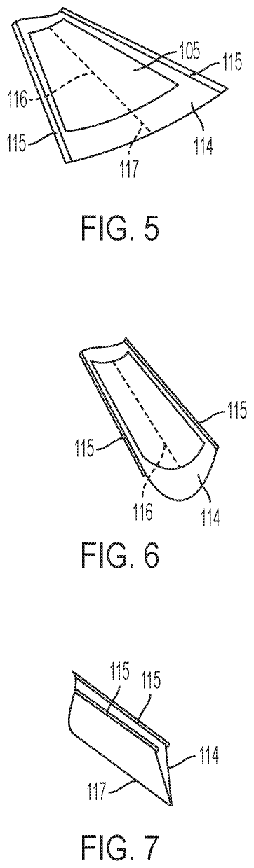

FIGS. 5-7 illustrate how the solar panel 105 can preferably flex or fold when the umbrella 101 is stowed.

Each panel 114 may define a fold line 117 generally equidistant between the adjacent support arms 115 along which the panel 114 bends or folds when the umbrella 101 is stowed.

In one embodiment, each solar panel 105 is flexible so that the solar panel 105 is able to bend as the support arms 115 close together.

In further embodiments, each solar panel 105 may comprise a pair of rigid portions 118 which are connected together at the fold line 116 by a hinge 119. In embodiments, the hinge 119 may be a living hinge. As such, when the umbrella 101 is collapsed, the rigid portions 118 fold with respect to the hinge 119 therebetween.

In a preferred embodiment, each panel 105 is configured to fold along the fold line 116 and is also flexible. In this way, each panel 105 is able to fold with the folding of the respective panel 114 and is also able to wrap around the shaft 108.

In embodiments, the powering circuitry 104 may comprise a switch 119 configured to detect when the solar panel 105 is unfolded or when the structure 101 is erected or stowed. A switch sensing cable 120 may run through the shaft 108 to the charge controller 113 or the power controller 109 so that the charge controller 113 or the power controller 109 is able to detect when the solar panels 105 are unfolded to thereby either charge the battery 106 or provide power via the charging port 110.

In embodiments, when the circuitry 104 detects that the solar panel 105 is closed, the power controller 109 may draw power from the battery 106. However, when the circuitry 104 detects that the solar panel is open, the power controller 109 may draw power directly from the solar panel 105.

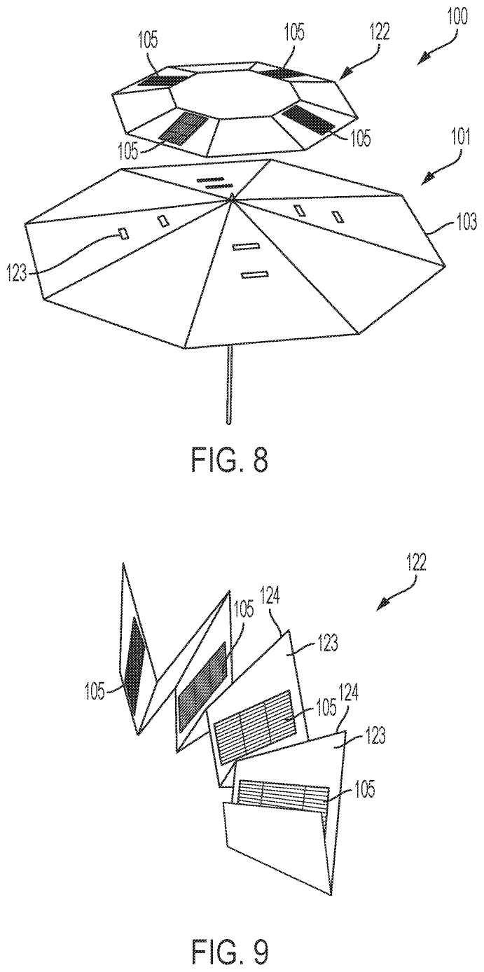

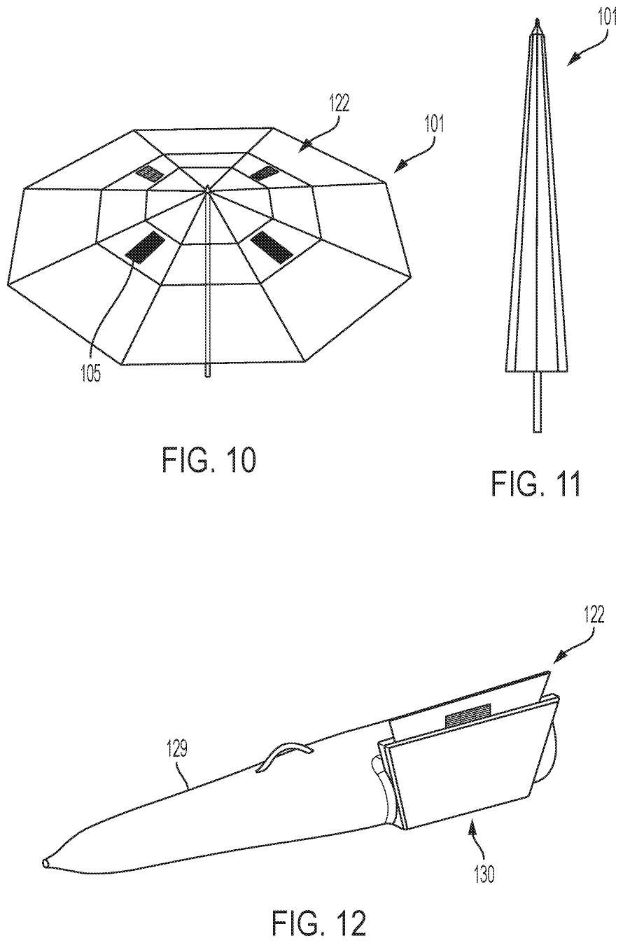

As alluded to above, FIG. 8 shows an embodiment wherein the solar panels 105 are releasably attachable to the umbrella 101. In accordance with this embodiment, the system 100 may comprise an solar panel attachment 122 which attaches to the fabric covering 103 of the umbrella 101. In accordance with the embodiment shown, the solar panel attachment 122 is generally annular defining an interior opening. Fasteners 123 (such as hook and loop fasteners) may be installed on the upper surface of the fabric covering 103 and wherein the solar panel attachment 122 has corresponding fasteners there underneath. As such, the fasteners 123 allow the solar panel attachment 122 to be attached to the upper surface of the fabric covering 103.

FIG. 9 illustrates the foldability of the solar panel attachment 122. The solar panel attachment 122 may comprise a plurality of segments 123 of flexible backing, preferably of fabric. In accordance with the embodiment shown, the solar panel attachment 122 is designed to concertina with fold lines 124 between the segments 123. Each segment 123, or alternative segments 123 may have respective solar panels 105 installed thereon. The solar panels 105 may be rigid, but are preferably flexible plastic solar panels 105.

FIG. 16 shows a top plan view of the solar panel attachment 122 when opened illustrating each segment 123 supporting a respective solar panel 105 thereon. Interconnecting wiring 126 may interconnect the solar panels 105 in parallel or series.

Ends of the flexible backing of the solar panel attachment 122 may attach together using an end attachment 127. In the embodiment shown, the end attachment 127 may comprise a fold over flap of hook and loop fasteners. In accordance with this embodiment, the fold lines 120 between the segments 123 form generally trapezoidal segments 123 so that when the end attachment 127 is connected together, the solar panel attachment 122 generally takes the aforedescribed annular shape.

The interconnecting wiring 126 may be run between the panels 105 except across the attachment end 127 wherein rather returns to the shaft 108.

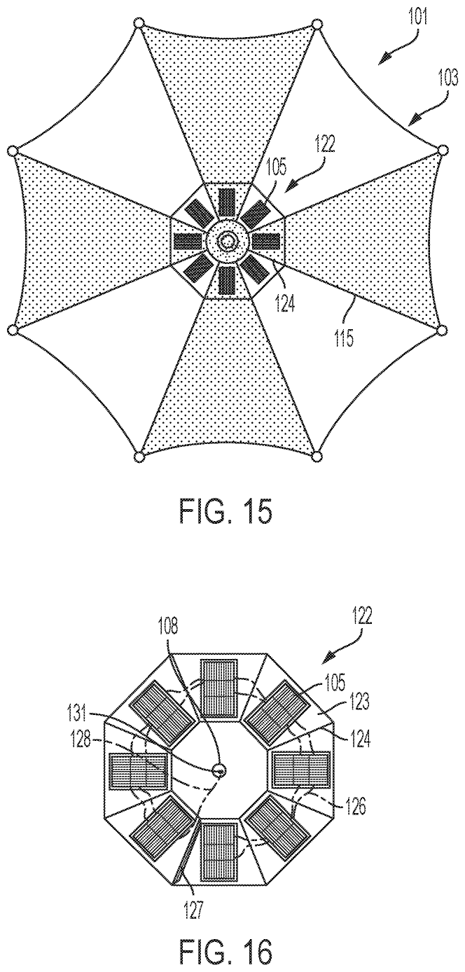

In embodiments in FIG. 16, the solar panel attachment 122 may comprise a power lead 128 which is connected to the aforedescribed port 131 in the end cap 121 of the umbrella 101. As such, when the solar panel attachment 122 is unfolded and fastened to the fabric covering 103 of the umbrella 101 around the shaft 108 as is illustrated in FIG. 15, the electrical lead 128 may be plugged into the port 131 in the end cap 121. The aforedescribed circuitry 104 componentry may be installed within the shaft 108 or handle of the umbrella 101.

As is evident from FIGS. 15 and 16, the fold lines 124 may coincide with the radial arms 115 of the umbrella 101 so that when the umbrella 101 is folded, the solar panel attachment 122 folds conformably to thereby allow the umbrella 101 to take for the configuration illustrated in FIG. 11.

Whereas the folded configuration given in FIG. 11 may not be as compact with the solar panel attachment 122 installed, FIG. 12 shows an embodiment wherein the solar panel attachment 122 may be separately carried. In accordance with this embodiment, the system 100 comprises an elongate umbrella carry case 129 which is designed to fit the umbrella 101 therein when folded. However, the carry case 129 further comprises a side carry pouch 130. When the solar panel attachment 122 is folded in the manner illustrated in FIG. 9, it may take on a generally rectangular flat configuration which can slide into the side carry pouch 130. As such, the umbrella can be folded into a tight compact configuration without hindrance from the solar panel attachment 122.

FIG. 14 shows the solar panel attachment 122 configured to attach to a gazebo 101. In accordance with this embodiment, the fold lines 124 of the attachment piece may generally conform with the radial arms 115 of the gazebo 101. As such, the solar panel attachment 122 can fold conformably with the gazebo 101. In accordance with this embodiment, the solar panel attachment 122 may be rectangular when attached to the fabric covering 103 of the gazebo 101 as compared to the annular shape for the umbrella 101 described above.

The foregoing description, for purposes of explanation, used specific nomenclature to provide a thorough understanding of the invention. However, it will be apparent to one skilled in the art that specific details are not required in order to practise the invention. Thus, the foregoing descriptions of specific embodiments of the invention are presented for purposes of illustration and description. They are not intended to be exhaustive or to limit the invention to the precise forms disclosed as obviously many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following claims and their equivalents define the scope of the invention.

1. A sunshade solar power system comprising:
a sunshade having a support frame and a fabric covering, the fabric covering defining an upper surface;
a solar powering circuitry comprising:
a solar panel located across the upper surface,
a power controller, and
a charging port operably connected to the power controller, wherein the power controller is configured for recharging a device connected to the charging port with energy converted by the solar panel.

2. The system as claimed in claim 1, further comprising a rechargeable battery operably connected to the solar panel and wherein the power controller is further operably connected to the battery and wherein the system is configured for recharging the battery with solar energy converted by the solar panel and for recharging a device connected to the charging port with energy stored by the rechargeable battery.

3. The system as claimed in claim 2, further comprising a charge sensor operably connected to the battery.

4. The system as claimed in claim 3, further comprising a charge indicator operably connected to the charge sensor, the charge indicator configured for indicating a charge state determined by the charge indicator.

5. The system as claimed in claim 3, wherein the charge sensor is operably coupled to the power controller and wherein the system is configured for inhibiting power draw via the power controller of the charge sensor detects a charge state less than a threshold.

6. The system as claimed in claim 1, wherein the support frame is a collapsible so that the fabric covering is configurable between a deployed configuration wherein the fabric covering is generally flat and a stowed configuration wherein the fabric covering is folded and wherein the solar panel is configured to at least one of bend and fold when the support frame is collapsed.

7. The system as claimed in claim 1, wherein the solar panel is configured to at least one of flex and bend along a central fold line thereof.

8. The system as claimed in claim 7, wherein the structure is an umbrella and wherein the solar panel is connected between radial arms thereof and wherein the central fold line runs generally between the radial arms.

9. The system as claimed in claim 8, wherein the solar panel is flexible.

10. The system as claimed in claim 8, wherein the solar panel is foldable.

11. The system as claimed in claim 10, wherein the solar panel comprises hingedly coupled panel portions.

12. The system as claimed in claim 8, wherein the solar panel is flexible and foldable.

13. The system as claimed in claim 6, further comprising a switch configured to detect whether the solar panel is open or closed and wherein the switch operably interfaces the charge controller so that the charge controller only charges the battery when the solar panel is open.

14. The system as claimed in claim 6, further comprising a switch configured to detect whether the solar panel is open or closed and wherein the switch operably interfaces the charge controller so that the power controller only provides power via the charging port when the solar panel is open.

15. The system as claimed in claim 6, further comprising a switch configured to detect whether the solar panel is open or closed and wherein the power controller is configured to bypass the battery when the solar panel is open.

16. The system as claimed in claim 1, wherein the structure is an umbrella and wherein the solar panel is connected between radial arms thereof and wherein the solar panel is generally trapezoidal.

17. The system as claimed in claim 1, wherein the power controller is configured to bypass the battery when power supply from the solar panel exceeds that which is drawn by the charging port.

18. The system as claimed in claim 17, wherein the system comprises a current sensor to measure current flow from the solar panel and a current sensor to measure current draw from the charging port and wherein the current sensors are used to determine if the solar panel is able to provide sufficient power drawn from the charging port.

19. The system as claimed in claim 17, wherein the system comprises switching either connecting the power controller to the battery when not in a bypass mode and connecting the power controller to the solar panel when in the bypass mode.

20. The system as claimed in claim 17, wherein the system comprises a subcircuit allowing the power controller to draw power proportionately from the solar panel and the battery to meet the current draw from the charging port.

21. The system as claimed in claim 1, wherein the sunshade is an umbrella and wherein the charging port is accessible through a central shaft of the umbrella so that the charging port is accessible irrespective of whether the umbrella is open or closed.

22. The system as claimed in claim 1, wherein the charging port is located at a proximal end of the shaft.

23. The system as claimed in claim 22, wherein the charging port is located at a proximal end of the shaft so as to be exposed even when the umbrella is closed.

24. The system as claimed in claim 23, wherein the charging port is installed in a handle terminating the proximal end of the shaft.

25. The system as claimed in claim 1, wherein the sunshade is an umbrella and wherein the charging port is accessible from a distal end of a central shaft of the umbrella.

26. The system as claimed in claim 25, wherein the charging port is accessible above a fabric covering of the umbrella.

27. The system as claimed in claim 26, wherein the umbrella comprises an end cap and wherein the charging port is installed in the end cap.

28. The system as claimed in claim 1, wherein the sunshade is an umbrella and wherein a distal end of a central shaft of the umbrella comprises an intake port to take power from a solar panel attachment, the solar panel attachment having the solar panel, being configured to attach to a fabric covering of the umbrella and having a charging cable configured to connect to the intake port.

29. The system as claimed in claim 1, wherein the solar panel is releasably attachable to the sunshade.

30. The system as claimed in claim 1, wherein the system comprises a solar panel attachment having the solar panel, the solar panel attachment configured to attach to a fabric covering of the sunshade.

31. The system as claimed in claim 30, wherein the solar panel attachment has a flexible backing.

32. The system as claimed in claim 31, wherein the flexible backing has a plurality of segments, wherein at least one of the segments retains the solar panel.

33. The system as claimed in claim 31, wherein the flexible backing is less rigid than the solar panel.

34. The system as claimed in claim 31, wherein the solar panel is flexible.

35. The system as claimed in claim 32, wherein the solar panel attachment has fold lines between the segments.

36. The system as claimed in claim 35, wherein the solar panel attachment is configured to concertina along the fold lines.

37. The system as claimed in claim 35, wherein the fold lines align with radial arms of the sunshade.

38. The system as claimed in claim 30, wherein the sunshade is an umbrella and wherein the solar panel attachment is generally annular and configured to attach to an upper surface of a fabric covering of the umbrella to surround a central shaft of the umbrella.

39. The system as claimed in claim 38, wherein the solar panel attachment has a flexible backing having fold lines defining segments therebetween and wherein the fold lines define trapezoidal segments.

40. The system as claimed in claim 30, wherein the solar panel attachment comprises a plurality of solar panels and wherein the solar panel attachment comprises interconnecting wiring interconnecting the solar panels.

41. The system as claimed in claim 40, wherein the interconnecting wiring interfaces a charging cable and wherein the charging cable is configured to connect to an intake port of the sunshade.

42. The system as claimed in claim 41, wherein the sunshade is an umbrella and wherein the charging port is installed in an end cap at a distal end of the umbrella.

43. The system as claimed in claim 31, wherein ends of the flexible backing are configured to attach to each other.

44. The system as claimed in claim 43, wherein ends of the flexible backing attach together with a fold of a flap and hook and loop fasteners.

45. The system as claimed in claim 31, wherein the sunshade is an umbrella and wherein the system comprises a carry case configured to fit the umbrella therein when folded and wherein the carry case has a separate carry pouch for the solar panel attachment when folded.

46. The system as claimed in claim 45, wherein the solar panel attachment is configured to fold generally to a rectangular configuration and wherein the carry pouch is generally rectangular.

47. The system as claimed in claim 1, wherein sunshade comprises integral lights which are operably coupled to a battery of the solar powering circuitry to provide illumination when dark.

48. The system as claimed in claim 47, wherein sunshade takes the form of an umbrella and wherein the lights are installed under radial arms thereof.

49. The system as claimed in claim 47, when the solar powering circuitry monitors at least one of current and voltage levels obtained from the solar panel to detect when it is dark to automatically operate the lights.
